(19) United States
(12) Patent Application Publication
(10) Pub. No.: US 2006/0095905 A1
(43) Pub. Date: May 4, 2006

(54) METHOD AND APPARATUS FOR SERVICING THREADS WITHIN A MULTI-PROCESSOR SYSTEM

(75) Inventors: Adam J. Courchesne, Jericho, VT (US); Kenneth J. Goodnow, Essex Junction, VT (US); Gregory J. Mann, Winfield, IL (US); Jason M. Norman, South Burlington, VT (US); Stanley B. Stanski, Essex Junction, VT (US); Scott T. Vento, Essex Junction, VT (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUSINESS MACHINES CORPORATION, Armonk, NY (US)

(21) Appl. No.: 10/904,259

(22) Filed: Nov. 1, 2004

(51) Int. Cl. G06F 9/46

(52) U.S. Cl. 718/100

(57) ABSTRACT

A method for servicing threads within a multi-processor system is disclosed. In response to an input/output (I/O) request to a peripheral by a thread, a latency time is assigned to the thread such that the thread will not be interrogated until the latency time has lapsed. After the latency time is lapsed, a determination is made as to whether or not the I/O request has been responded. If the I/O request has not been responded after the latency time is lapsed, the latency time is assigned to the thread again. Otherwise, if the I/O request has been responded after the latency time is lapsed, the latency time is updated with an actual response time. The actual response time is from a time when the I/O request was made to a time when the I/O request was actually responded.

### BACKGROUND OF THE INVENTION

1. Technical Field

The present invention relates to data processing in general, and, in particular, to a method for managing a data processing system having multiple processors. Still more particularly, the present invention relates to a method and apparatus for servicing threads within a multi-processor system.

2. Description of Related Art

During the operation of a multi-processor system, many peripherals can interface with different processors, each processor potentially having several threads being executed. Quite often, a thread makes multiple input/output (I/O) requests to a peripheral. If the peripheral is not ready to handle all the I/O requests, the operating system (or a device driver) can either continue to poll the peripheral or start processing another thread and come back to the previous thread some time later.

The main problem with switching from one thread to another thread is that each time a processor switches execution from one thread to another thread, all the corresponding data and code previously stored in a cache memory associated with the processor need to be reloaded from a system memory or a hard disk. Thus, any speed advantage received from caching a program is lost since the cache memory is flushed on each context switch.

In addition, each thread can be woken up by the operating system at an arbitrary time to check if its I/O requests have been responded. The unnecessary context switching or polling by the operating system may lead to a long latency.

Consequently, it would be desirable to provide an improved method and apparatus for servicing threads within a multi-processor system.

### SUMMARY OF THE INVENTION

In accordance with a preferred embodiment of the present invention, in response to an input/output (I/O) request to a peripheral by a thread, a latency time is assigned to the thread such that the thread will not be interrogated until the latency time has lapsed. After the latency time is lapsed, a determination is made as to whether or not the I/O request has been responded. If the I/O request has not been responded after the latency time is lapsed, the latency time is assigned to the thread again. Otherwise, if the I/O request has been responded after the latency time is lapsed, the latency time is updated with an actual response time. The actual response time is from a time when the I/O request was made to a time when the I/O request was actually responded.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a multi-processor system, in accordance with a preferred embodiment of the present invention;

FIG. 2 is a block diagram of a latency management device within the multi-processor system from FIG. 1, in accordance with a preferred embodiment of the present invention; and

FIG. 3 is a high-level logic flow diagram of a method for servicing threads within the multi-processor system from FIG. 1, in accordance with a preferred embodiment of the present invention.

### DETAILED DESCRIPTION OF A PREFERRED EMBODIMENT

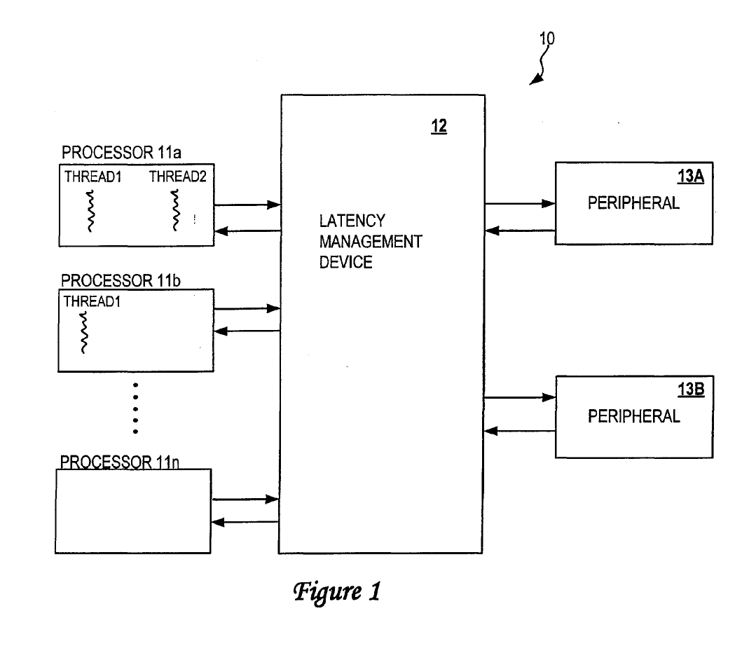

Referring now to the drawings and in particular to FIG. 1, there is depicted

a block diagram of a multi-processor system, in accordance with a preferred embodiment of the present invention. As shown, a multi-processor system 10 includes processors 11a-11n. Multi-processor system 10 also includes peripherals 13a-13b coupled to processors 11a-11n via a latency management device 12. Peripherals 13a-13b are various input/output (I/O) devices, such as hard drives, tape drives, etc., that are well-known in the art. Each of processors 11a-11n is capable of communicating to any of peripherals 13a-13b via latency management device 12.

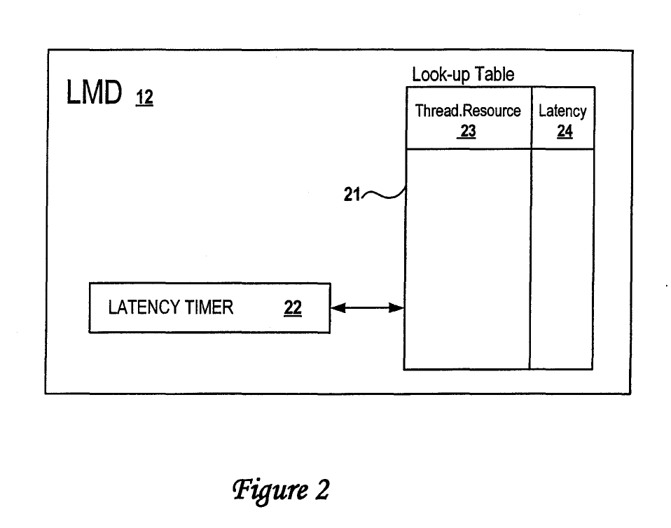

With reference now to FIG. 2, there is depicted a detailed block diagram of latency management device 12, in accordance with a preferred embodiment of the present invention. As shown, latency management device 12 includes a look-up table 21 and a latency timer 22. Look-up table 21 includes multiple entries, and each entry preferably includes two fields, namely, a thread.resource field 23 and a latency field 24. Within each entry, thread.resource field 23 contains a thread and a resource to which an I/O request was made by the thread, and latency field 24 contains the corresponding historical latency time (preferably in terms of processor cycle) for the thread-resource combination. During operation, a thread along with a resource can be sent to look-up table 21 to obtain a corresponding latency time from latency field 24 for the thread-resource combination.

After an I/O request to a peripheral (or resource) is made by a thread, latency timer 22 captures the actual start time of the I/O request. Latency timer 22 also captures the actual stop time of a response to the I/O request. The time difference between the actual start time and the actual stop time is the actual latency time for that thread-resource combination. A running average (or median) of the most recent latency time for each thread-resource combination is stored in latency field 24 of look-up table 21. For the present embodiment, the running average is preferably determined by ten most recent latency time of a thread-resource combination.

During power-up, the operating system preloads each entry of look-up table 21 with thread and resource information in thread.resource field 23 along their corresponding latency time in latency field 24. At this point, the latency times are simply “good guesses” based on historical performances of the data processing system.

During operation, for each new thread that is forked, the operating system informs latency management device 12 to declare a new entry within look-up table 21 for the new thread. In addition, the operating system also informs latency management device 12 which thread is initiating an I/O request. An easy way to inform latency management device 12 of all on-going threads is to have each application program to make a write access to latency management device 12 every time a thread is initiated. Each application program also need to make a write access to latency management device 12 every time a thread resumes from a pause. Latency management device 12 can then assume that the last identified thread is making all I/O requests until latency management device 12 receives another write access to indicate that a new thread is running.

As a thread is being executed, latency management device 12 maintains a running average of a latency time of the most recent I/O requests to various resources from the thread. Thus, latency management device 12 provides a predictive thread management through a dynamic per thread/per I/O request via look-up table 21.

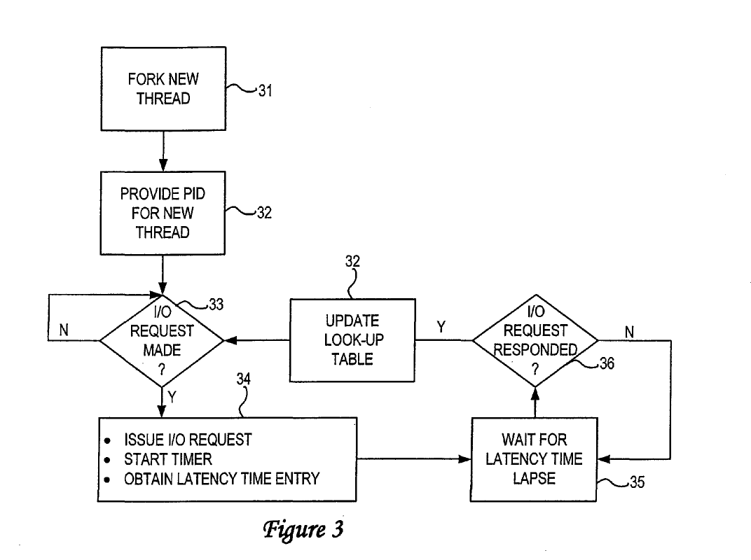

Referring now to FIG. 3, there is depicted a high-level logic flow diagram of a method for serving threads within a multi-processor system, such as multi-processor system 10 from FIG. 1, in accordance with a preferred embodiment of the present invention. When a thread is generated, as shown in block 31, the operating system provides a new process identification (PID) for the newly generated thread to a latency management device, such as latency management device 1 2 from FIG. 2, as depicted in block 32.

When the thread makes an I/O request to a resource (or peripheral) via a system call to the operating system, the operating system performs the following functions. First, the operating system submits the I/O request to the resource on behalf of the thread, as shown in block 34. At which point, a latency timer, such as latency time 22 from FIG. 2, within the latency management device starts the timer for that thread-resource combination. The operating system then reads a corresponding latency time entry for the thread-resource combination in a look-up table, such as look-up table 21 from FIG. 2, of the latency management device, and subsequently ignores the thread for the time (preferably in terms of processor cycles) indicated in the latency field of the look-up table, as depicted in block 34. The operating system may service other threads at this point.

After the time indicated in the latency time field has lapsed, the operating system returns to the original thread to determine whether or not the I/O request has been responded, as shown in shown in block 36. If the I/O request has not been responded, the operating system again ignores the thread for the same time previously indicated in the latency field of the look-up table, and the operating system is free to service other threads.

Otherwise, when the I/O request has been responded, the running average latency time in the look-up table for the thread.resource combination is updated by the latency management device based on the new response time, as shown in block 37. Since the new response time can be shorter or longer than the average latency time previously indicated, the average latency time will be adjusted accordingly.

With the present invention, several system tasks can potentially be shifted to a hardware core. For example, in an inter-process communication (hardware semaphore), a register can be provided with bits that can be independently, atomically written and read for use as a mutual exclusion lock.

Resources can be allocated more efficiently to avoid bottlenecks or deadlocks. If one processor is busy with an application, a thread can be allocated to another processor that is idle. Slower peripherals can be set with a lower priority so that their interrupts and I/O requests will be put on hold until a processor is available to accept transactions.

As has been described, the present invention provides an improved method and apparatus for servicing multiple threads within a multi-processor system. The present invention provides a hardware device that keeps an I/O latency running average for each thread accessing each peripheral device. Rather than putting the thread to sleep for an arbitrary amount of time, the operating system reads an entry from a look-up table for a more accurate prediction based on the history of the I/O response time. The present invention is particularly beneficial to large data processing system having peripherals with long and regular latency or frequent interrupts.

An example of a peripheral that requires a large latency and can potentially be benefited from the present invention is an universal serial bus (USB) mouse. Once an I/O request has been made, the response will return after the USB mouse has returned to a normal power state, read the data, wait for available slot in the latency management device window, and send the data. Such type of data access can be long and regular, and would greatly benefit from the historical latency analysis of the present invention.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for servicing threads within a data processing system, said method comprising:
in response to an input/output (I/O) request to a peripheral by a thread, assigning a latency time to said thread such that said thread will not be interrogated until said latency time has lapsed;
after said latency time is lapsed, determining whether or not said I/O request has been responded;
in response to a determination that said I/O request has not been responded after said latency time is lapsed, assigning said latency time to said thread again; and
in response to a determination that said I/O request has been responded after said latency time is lapsed, updating said latency time with an actual response time, wherein said actual response time is from a time when said I/O request was made to a time when said I/O request was actually responded.

2. The method of claim 1, wherein said method further includes providing a look-up table, wherein said look-up table includes a plurality of entries, each entry includes a thread.resource field and a latency field.

3. The method of claim 1, wherein said assigning further includes traversing said look-up table to obtain said latency time, wherein said latency time is an estimate time required for servicing said I/O request from said thread.

4. The method of claim 1, wherein said method further includes issuing said I/O request.

5. The method of claim 1, wherein said method further includes determining said actual response time by measuring a time between said I/O request was made and said I/O request was responded.

6. The method of claim 1, wherein said updating further includes determining a running average of latency time by using said actual response time.

7. A computer program product residing on a computer usable medium for servicing threads within a data processing system, said computer program product comprising:
in response to an input/output (I/O) request to a peripheral by a thread, program code means for assigning a latency time to said thread such that said thread will not be interrogated until said latency time has lapsed;
program code means for determining whether or not said I/O request has been responded after said latency time is lapsed;
program code means for assigning said latency time to said thread again, in response to a determination that said I/O request has not been responded after said latency time is lapsed; and
program code means for updating said latency time with an actual response time, in response to a determination that said I/O request has been responded after said latency time is lapsed, wherein said actual response time is from a time when said I/O request was made to a time when said I/O request was actually responded.

8. The computer program product of claim 7, wherein said computer program product further includes program code means for providing a look-up table, wherein said look-up table includes a plurality of entries, each entry includes a thread.resource field and a latency field.

9. The computer program product of claim 7, wherein said program code means for assigning further includes program code means for traversing said look-up table to obtain said latency time, wherein said latency time is an estimate time required for servicing said I/O request from said thread.

10. The computer program product of claim 7, wherein said computer program product further includes program code means for issuing said I/O request.

11. The computer program product of claim 7, wherein said computer program product further includes program code means for determining said actual response time by measuring a time between said I/O request was made and said I/O request was responded.

12. The computer program product of claim 7, wherein said program code means for updating further includes program code means for determining a running average of latency time by using said actual response time.

13. An apparatus residing on a computer usable medium for servicing threads within a data processing system, said apparatus comprising:
in response to an input/output (I/O) request to a peripheral by a thread, means for assigning a latency time to said thread such that said thread will not be interrogated until said latency time has lapsed;
means for determining whether or not said I/O request has been responded after said latency time is lapsed;
means for assigning said latency time to said thread again, in response to a determination that said I/O request has not been responded after said latency time is lapsed; and
means for updating said latency time with an actual response time, in response to a determination that said I/O request has been responded after said latency time is lapsed, wherein said actual response time is from a time when said I/O request was made to a time when said I/O request was actually responded.

14. The apparatus of claim 13, wherein said apparatus further includes a look-up table having a plurality of entries, each entry includes a thread.resource field and a latency field.

15. The apparatus of claim 13, wherein said means for assigning further includes means for traversing said look-up table to obtain said latency time, wherein said latency time is an estimate time required for servicing said I/O request from said thread.

16. The apparatus of claim 1 3, wherein said apparatus further includes means for issuing said I/O request.

17. The apparatus of claim 13, wherein said apparatus further includes means for determining said actual response time by measuring a time between said I/O request was made and said I/O request was responded.

18. The apparatus of claim 13, wherein said means for updating further includes means for determining a running average of latency time by using said actual response time.
